(19) United States
(12) Patent Application Publication
(10) Pub. No.: US 2023/0016862 A1
(43) Pub. Date: Jan. 19, 2023

(54) DESIGN METHOD FOR SIX-POLE HYBRID MAGNETIC BEARING WITH SYMMETRICAL SUSPENSION FORCES

(71) Applicant: HUAIYIN INSTITUTE OF TECHNOLOGY, Huaian City (CN)

(72) Inventors: Xiaoting YE, Huaian City (CN); Zixin WANG, Huaian City (CN); Qianyun LE, Huaian City (CN); Tao ZHANG, Huaian City (CN); Shasha WU, Huaian City (CN); Qing LU, Huaian City (CN); Lihong MO, Huaian City (CN); Weihong DING, Huaian City (CN)

(21) Appl. No.: 17/781,785

(22) PCT Filed: Jan. 14, 2021
(86) PCT No.: PCT/CN2021/071727

§ 371 Date: Jun. 2, 2022

(30) Foreign Application Priority Data
Jan. 17, 2020 (CN) 202010055306.2

(51) Int. Cl. F16C 32/04

(52) U.S. Cl. CPC F16C 32/048; F16C 32/0459

(57) ABSTRACT

A design method for a six-pole hybrid magnetic bearing with symmetrical suspension forces. A magnetic bearing is designed by taking particularity that a permanent magnet of the six-pole hybrid magnetic bearing with symmetrical suspension forces forms magnetic polarity on a stator suspension tooth as the starting point and taking maximum suspension forces in x and y directions and a saturation magnetic density as constraint conditions. Compared with a method for designing the maximum radial suspension force in a +x direction in a manner that a saturation magnetic induction intensity is reached in the +x direction and the magnetic induction intensity in a −x direction is zero in existing design of a six-pole hybrid magnetic bearing, this method enables the maximum magnetic suspension forces in the +x and +y directions to be same, so that the radial suspension forces of the six-pole hybrid magnetic bearing are designed to be completely symmetrical.

### TECHNICAL FIELD

The present invention relates to a design method for a hybrid magnetic suspension bearing, and in particular, to a design method for a six-pole hybrid magnetic bearing with symmetrical suspension forces. The design idea of the method can be used as the design of hybrid magnetic bearings with other structures of the same type.

### BACKGROUND

The present invention relates to a six-pole hybrid magnetic bearing, of which the suspension forces in an X direction and a Y direction are designed to be symmetrical, the structure is shown in FIG. 1, and the radial magnetic flux is shown in FIG. 2. The magnetic bearing includes a stator and a rotor located in an inner race of the stator. The stator is an integral whole composed of a left stator core, a left axially magnetized permanent magnet ring, a middle stator core, a right axially magnetized permanent magnet ring, and a right stator core arranged in sequence from left to right. The left, middle and right stator cores are each provided with a pair of suspension teeth of equal width evenly distributed along the inner circumference, and the suspension teeth are respectively recorded as a suspension tooth X, a suspension tooth Y, a suspension tooth Z, a suspension tooth V, a suspension tooth W, and a suspension tooth U. The suspension teeth X, Y, V, and W are all bent in opposite directions. The rotor includes a cylindrical rotor core and a rotating shaft. The end faces of the suspension teeth X, Y, Z, V, W, and U close to the rotor core match the radian of the circumferential surface of the rotor core, have the same axial width as the rotor core, and are coplanar with the rotor core in the radial direction. The suspension tooth Z is located on a +x axis. The suspension teeth X, Y, Z, V, W, and U are 60 degrees different from each other on the circumference, and air gaps between the suspension teeth X, Y, Z, U, V, and W and the rotor core are equal in length. Centralized radial control windings with the same number of turns are wound on the six suspension teeth X, Y, Z, U, V, and W, and are respectively recorded as a first control winding to a sixth control winding. The control windings on two opposite suspension teeth are connected in series. The bias magnetic fluxes of the suspension teeth X, Y and V, W of the left and right stator iron cores are opposite to the bias magnetic flux of the suspension teeth Z, U of the middle stator iron core in direction.

For a magnetic bearing, the saturation magnetic induction intensity and magnetic pole area thereof jointly determine the bearing capacity of the magnetic bearing. In the design of exiting six-pole magnetic bearings, the maximum radial suspension force in a +x direction is designed in a manner that a saturation magnetic induction intensity is reached in the +x direction and the magnetic induction intensity in a −x direction is zero. Due to the structural characteristics of the six-pole magnetic bearings, this method results in that the maximum suspension forces in the +x and +y directions are not equal, and such asymmetry makes the six-pole hybrid magnetic bearing unusable in some specific occasions.

### SUMMARY

Objectives of invention: in order to solve the problem of unequal maximum suspension forces in +x and +y directions caused by the conventional six-pole magnetic bearing design method, the present invention proposes a design method for a six-pole hybrid magnetic bearing with symmetrical suspension forces, so that the maximum suspension forces in the +x and +y directions are equal, and the radial suspension force of the six-pole magnetic bearing is completely symmetrical.

Technical solutions: the present invention is implemented through the following technical solutions:

A design method for a six-pole hybrid magnetic bearing with symmetrical suspension forces, where taking particularity that a permanent magnet of the six-pole hybrid magnetic bearing with symmetrical suspension forces forms magnetic polarity on a stator suspension tooth as the starting point, the method specifically includes the following steps:

step 1: calculating the maximum magnetic suspension force in a +x direction;

S1.1: according to the selected ferromagnetic material, determining the saturation magnetic induction intensity of a radial air gap under a suspension tooth Z in the +x direction as Bs, setting the bias magnetic induction intensity of radial air gaps under suspension teeth X, Y, V, and W to Bₚ, and determining the radial control magnetic induction intensity generated by radial control windings on the suspension teeth Z and U as Bₖₐ;

S1.2: according to the relationship of three-phase current when an AC magnetic bearing generates the maximum suspension force in the +x direction, determining the radial control magnetic induction intensities generated by radial control windings on the suspension teeth X and Y and radial control windings on the suspension teeth V and W as B_{kb} and B_{kc};

S1.3: determining the synthetic magnetic induction intensities of the radial air gaps under the six suspension teeth X, Y, Z, U, V, and W as Bₓ₁, B_{y1}, B_{z1}, Bᵥ₁, and B_{w1}; and

S1.4: setting the radial magnetic pole area Sᵣ of the suspension teeth X, Y, Z, U, V, and W, and the angular relationship corresponding to the six suspension teeth X, Y, Z, U, V, and W, and determining the expression of the maximum magnetic suspension force Fₓₘₐₓ in the +x direction;

step 2: calculating the maximum suspension force in a +y direction;

S2.1: according to the relationship of the three-phase current when the AC magnetic bearing generates the maximum suspension force in the +y direction, determining the radial control magnetic induction intensities generated by both the radial control windings on the suspension teeth X and Y and the radial control windings on the suspension teeth V and W as B_{y};

S2.2: according to the bias magnetic induction intensity of the radial air gaps under the suspension teeth X, Y, V, and W being Bₚ and the radial control magnetic induction intensities being both B_{y}, determining the synthetic magnetic induction intensities of the radial air gaps under the suspension teeth X, Y, V, and W as Bₓ₂, B_{y2}, Bᵥ₂, and B_{w2}; and

S2.3: according to the radial magnetic pole area Sᵣ of the suspension teeth X, Y, V, and W, and the angular relationship corresponding to the four suspension teeth X, Y, V, and W, determining the expression of the maximum magnetic suspension force F_{ymax} in the +y direction;

step 3: solving the equation of Fₓₘₐₓ=F_{ymax} to calculate the bias magnetic induction intensity of the radial air gaps under the suspension teeth X, Y, V, and W as Bₚ; and

step 4: calculating the radial magnetic pole area Sᵣ of the suspension teeth X, Y, Z, U, V, and W from the formula

$$F = \frac{{B}^{2} s}{2 {μ}_{0}} ,$$

where F is an electromagnetic attraction force, B is magnetic induction intensity, s is an area, and μ₀ is vacuum permeability.

Furthermore, the relationships of Bₖₐ, B_{kb}, and B_{kc} with Bₛ and Bₚ are:

Bₖₐ=Bₛ−2Bₚ; and

B_{kb}=B_{kc}=Bₚ−½Bₛ.

Furthermore, the angular relationship corresponding to the suspension teeth X, Y, Z, U, V, and W in S1.4 and S2.3 is that: these suspension teeth are 60 degrees different from each other on the circumference.

Furthermore, the expression of the maximum magnetic suspension force Fₓₘₐₓ in the +x direction is:

$${F}_{xmax} = \frac{\begin{matrix}[ {B}_{s}^{2} - {( 4 {B}_{p} - {B}_{s} )}^{2} + \frac{1}{2} {( 0.5 {B}_{s} )}^{2} + \frac{1}{2} {( 0.5 {B}_{s} )}^{2} - \\ \frac{1}{2} {( 0.5 {B}_{s} - 2 {B}_{p} )}^{2} - \frac{1}{2} {( 0.5 {B}_{s} - 2 {B}_{p} )}^{2} ] {S}_{r}\end{matrix}}{2 {μ}_{0}}$$

where μ₀ is vacuum permeability, and μ₀=4π×10⁻⁷ H/m.

Furthermore, the expression of the maximum magnetic suspension force F_{ymax} in the +y direction is:

$${F}_{ymax} = \frac{[ \frac{\sqrt{3}}{2} {( 2 {B}_{p} )}^{2} + \frac{\sqrt{3}}{2} {( - 2 {B}_{p} )}^{2} ] {S}_{r}}{2 {μ}_{0}} .$$

### Beneficial Effects

According to the present invention, compared with the conventional six-pole hybrid magnetic bearing of which the maximum suspension forces in the +x and +y directions are not equal, by designing the saturation magnetic induction intensity and magnetic pole area, the maximum levitation forces in the +x and +y directions are equal, thereby achieving completely symmetrical design of the radial suspension force of the six-pole magnetic bearing.

### BRIEF DESCRIPTION OF THE DRAWINGS

FIG. 1 is a structural diagram of a six-pole hybrid magnetic bearing with symmetrical suspension forces.

FIG. 2 is a radial magnetic flux diagram of a six-pole hybrid magnetic bearing with symmetrical suspension forces.

1—Left stator core; 2—Left axially magnetized permanent magnet ring; 3—Middle stator core; 4—Right axially magnetized permanent magnet ring; 5—Right stator core; 6—First control winding; 7—Rotor core; 8—Rotating shaft; 9—Second control winding; 10—Third control winding; 11—Fourth control winding; 12—Fifth control winding; 13—Sixth control winding; 14—Bias flux Bₚ generated by a radial air gap of the left axially magnetized permanent magnet ring under suspension teeth X and Y; 15—Bias flux Bₚ generated by a radial air gap of the right axially magnetized permanent magnet ring under suspension teeth V and W; and 16—Control magnetic flux B_{kb} on the left stator core 1.

### DETAILED DESCRIPTION

The present invention is described in detail below with reference to the accompanying drawings.

In the description of the present invention, it should be understood that, orientations or position relationships indicated by terms such as “center”, “longitudinal”, “transverse”, “length”, “width”, “thickness”, “up”, “down”, “front”, “rear”, “left”, “right”, “vertical”, “horizontal”, “top”, “bottom”, “inner”, “outer”, “clockwise”, “counterclockwise”, “axial”, “radial”, and “circumferential” are orientations or position relationships shown based on the accompanying drawings, and are used only for ease of describing the present invention and simplifying the description, rather than indicating or implying that the apparatus or element should have a particular orientation or be constructed and operated in a particular orientation, and therefore, should not be construed as a limitation on the present invention.

In addition, terms “first” and “second” are used merely for the purpose of description, and shall not be construed as indicating or implying relative importance or implying a quantity of indicated technical features. Therefore, features defining “first” and “second” can explicitly or implicitly include at least one of the features. In the descriptions of the present invention, unless explicitly specified, “multiple” means at least two, for example, two or three.

In the present invention, it should be noted that unless otherwise clearly specified and limited, the terms “mounted”, “connected”, “connection”, and “fixed” should be understood in a broad sense. For example, a connection may be a fixed connection, a detachable connection, or an integral connection; may be a mechanical connection or an electrical connection; may be a direct connection or an indirect connection by means of an intermediate medium; or may be internal communication between two elements or interaction relationship between two elements, unless otherwise clearly limited. A person of ordinary skill in the art can understand specific meanings of the terms in the present invention based on specific situations.

The present invention relates to a design method for a hybrid magnetic suspension bearing, and in particular, to a design method for a six-pole hybrid magnetic bearing with symmetrical suspension forces. The design idea of the method can be used as the design of hybrid magnetic bearings with other structures of the same type. Moreover, according to the general design method for magnetic bearings, the following assumptions are made for the six-pole hybrid magnetic bearing with symmetrical suspension forces: only the reluctance of the working air gap is considered, the reluctance of the left, middle and right stator cores and rotor cores is ignored, and the magnetic flux leakage and eddy current effect are ignored.

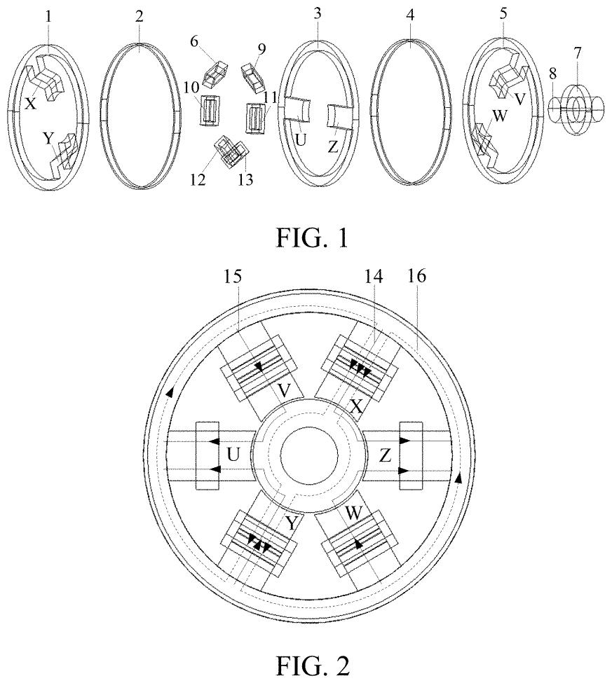

The present invention is designed based on the following structure, and the suspension forces in an X direction and a Y direction are designed to be symmetrical, the structure is shown in FIG. 1, and the radial magnetic flux is shown in FIG. 2. The magnetic bearing includes a stator and a rotor located in an inner race of the stator. The stator is an integral whole composed of a left stator core 1, a left axially magnetized permanent magnet ring 2, a middle stator core 3, a right axially magnetized permanent magnet ring 4, and a right stator core 5 arranged in sequence from left to right. The left, middle and right stator cores are each provided with a pair of suspension teeth of equal width evenly distributed along the inner circumference, and the suspension teeth are respectively recorded as a suspension tooth X, a suspension tooth Y, a suspension tooth Z, a suspension tooth V, a suspension tooth W, and a suspension tooth U. The suspension teeth X, Y, V, and W are all bent in opposite directions. The rotor includes a cylindrical rotor core 7 and a rotating shaft 8. The end faces of the suspension teeth X, Y, Z, V, W, and U close to the rotor core 7 match the radian of the circumferential surface of the rotor core 7, have the same axial width as the rotor core 7, and are coplanar with the rotor core 7 in the radial direction. The suspension tooth Z is located on a +x axis. The suspension teeth X, Y, Z, V, W, and U are 60 degrees different from each other on the circumference, and air gaps between the suspension teeth X, Y, Z, U, V, and W and the rotor core 7 are equal in length. Centralized radial control windings with the same number of turns are wound on the six suspension teeth X, Y, Z, U, V, and W, and are respectively recorded as a first control winding to a sixth control winding. That is, the control winding wound on the suspension tooth X is the first control winding 6, the control winding wound on the suspension tooth Y is the sixth control winding 13, the control winding wound on the suspension tooth Z is the fourth control winding 11, the control winding wound on the suspension tooth U is the third control winding 10, the control winding wound on the suspension tooth V is the second control winding 9, and the control winding wound on the suspension tooth W is the fifth control winding 12. The control windings on two opposite suspension teeth are connected in series. That is, the suspension teeth X and Y are connected in series, the suspension teeth Z and U are connected in series, and the suspension teeth V and W are connected in series. The bias magnetic fluxes of the suspension teeth X, Y and V, W of the left and right stator iron cores (1, 5) are opposite to the bias magnetic flux of the suspension teeth Z, U of the middle stator iron core 3 in direction.

From the ferromagnetic material of the stator cores (left, middle and right stator cores), the saturation magnetic induction intensity of a radial air gap under the suspension tooth Z in a +x direction is determined as Bₛ. Assuming that the bias magnetic induction intensity of radial air gaps under the suspension teeth X, Y, V, and W is Bₚ, according to a magnetic circuit of a bias magnetic flux, the bias magnetic flux 14 generated by the radial air gap of the left axially magnetized permanent magnet ring 2 under the suspension teeth X and Y, starts from an N pole, passes through a yoke of the left stator core 1, the suspension teeth X and Y on the left stator core 1, and the rotor core 7, and enters the suspension teeth Z and U on the middle stator core 3 and a yoke of the middle stator core 3 to return to an S pole.

The bias magnetic flux 15 generated by the radial air gap of the right axially magnetized permanent magnet ring 4 under the suspension teeth V and W, starts from the N pole, passes through the yoke of the right stator core 5, the suspension teeth V and W on the right stator core 5, and the rotor core 7, and enters the suspension teeth Z and U on the middle stator core 3 and the yoke of the middle stator core 3 to return to the S pole.

The control magnetic flux 16 on the left stator core 1 (only the control magnetic flux B_{kb} on the left stator core 1 is drawn, and the control magnetic flux Bₖₐ on the middle stator core 3 and the control magnetic flux B_{kc}c on the right stator core 5 are similar to it) is shown in FIG. 2.

Therefore, the bias magnetic induction intensity of the radial air gaps under the suspension teeth Z and U is 2Bₚ, and the radial control magnetic induction intensity Bₖₐ generated by the third control winding 10 and the fourth control winding 11 wound on the suspension teeth Z and U in the radial direction is:

Bₖₐ=Bₛ−2Bₚ (1)

According to an energization method for the hybrid magnetic bearing to generate a maximum suspension force in the x direction, maximum control current iₓₘₐₓ in the x direction is introduced into the third control winding 10 and the fourth control winding 11 wound on the suspension teeth Z and U in the radial direction, and a negative half −0.5iₓₘₐₓ of the maximum control current in the x direction is introduced into the first control winding 6 and the sixth control winding 13 wound on the suspension teeth X and Y as well as the second control winding 9 and the fifth control winding 12 wound on the suspension teeth V and W, to generate the maximum suspension force Fₓₘₐₓ in the +x direction. The relational expression between the magnetic induction intensity and current is as follows:

$$B = \frac{Ni}{sR} \qquad ( 2 )$$

In formula (2), N is the number of turns of the winding, i is the current, s is the cross-sectional area of the magnetic circuit, and R is reluctance. Therefore, the radial control magnetic induction intensities generated by the first control winding 6 and the sixth control winding 13 wound on the suspension teeth X and Y, and the second control winding 9 and the fifth control winding 12 wound on the suspension teeth V and W are B_{kb} and B_{kc}, which are as follows:

B_{kb}=B_{kc}=Bₚ−½Bₛ.

Therefore, the synthetic magnetic induction intensities Bₓ₁, B_{y1}, B_{z1}, Bᵤ₁, Bᵥ₁, and B_{w1} of the radial air gaps under the six suspension teeth X, Y, Z, U, V, and W are as follows:

$$\{ \begin{matrix}{B}_{x 1} = 0.5 {B}_{s} \\ {B}_{y 1} = 0.5 {B}_{s} - 2 {B}_{p} \\ {B}_{z 1} = {B}_{s} \\ {B}_{u 1} = 4 {B}_{p} - {B}_{s} \\ {B}_{v 1} = 0.5 {B}_{s} - 2 {B}_{p} \\ {B}_{w 1} = 0.5 {B}_{s}\end{matrix} \qquad ( 4 )$$

By setting the radial magnetic pole area Sᵣ of the suspension teeth X, Y, Z, U, V, and W, and setting the six suspension teeth X, Y, Z, U, V, and W to be 60 degrees different from each other on the circumference, it can be derived that the expression of the maximum magnetic suspension force Fₓₘₐₓ in the +x direction is as follows:

$${F}_{xmax} = \frac{\begin{matrix}[ {B}_{s}^{2} - {( 4 {B}_{p} - {B}_{s} )}^{2} + \frac{1}{2} {( 0.5 {B}_{s} )}^{2} + \frac{1}{2} {( 0.5 {B}_{s} )}^{2} - \\ \frac{1}{2} {( 0.5 {B}_{s} - 2 {B}_{p} )}^{2} - \frac{1}{2} {( 0.5 {B}_{s} - 2 {B}_{p} )}^{2} ] {S}_{r}\end{matrix}}{2 {μ}_{0}} \qquad ( 5 )$$

In formula (5), μ₀ is vacuum permeability, and μ₀=4π×10⁻⁷ H/m.

According to an energization method for the hybrid magnetic bearing to generate a maximum suspension force in the y direction, the third control winding 10 and the fourth control winding 11 wound on the suspension teeth Z and U in the radial direction are not energized, negative maximum control current −i_{ymax} in the y direction is introduced into the first control winding 6 and the sixth control winding 13 wound on the suspension teeth X and Y, and maximum control current i_{ymax} in the y direction is introduced into the second control winding 9 and the fifth control winding 12 wound on the suspension teeth V and W, to generate the maximum suspension force F_{ymax} in the +y direction. According to formula (2) it is determined that the radial control magnetic induction intensities B_{yb} and B_{yc} generated by the first control winding 6 and the sixth control winding 13 wound on the suspension teeth X and Y, and the second control winding 9 and the fifth control winding 12 wound on the suspension teeth V and W are as follows:

$$\{ \begin{matrix}{B}_{yc} = 2 {B}_{p} \\ {B}_{yb} = - 2 {B}_{p}\end{matrix} \qquad ( 6 )$$

Therefore, the synthetic magnetic induction intensities Bₓ₂, B_{y2}, Bᵥ₂, and B_{w2} of the radial air gaps under the six suspension teeth X, Y, V, and W are as follows:

$$\{ \begin{matrix}{B}_{x 2} = 2 {B}_{p} \\ {B}_{y 2} = 0 \\ {B}_{v 2} = - 2 {B}_{p} \\ {B}_{w 2} = 0\end{matrix} \qquad ( 7 )$$

Thus, the expression of the maximum magnetic levitation force F_{ymax} in the +y direction is:

$${F}_{ymax} = \frac{[ \frac{\sqrt{3}}{2} {( 2 {B}_{p} )}^{2} + \frac{\sqrt{3}}{2} {( - 2 {B}_{p} )}^{2} ] {S}_{r}}{2 {μ}_{0}} \qquad ( 8 )$$

By solving the equation of Fₓₘₐₓ=F_{ymax}, it is derived that the bias magnetic induction intensity Bₚ of the radial air gaps under the suspension teeth X, Y, V, and W is as follows:

Bₚ=0.3714Bₛ (9)

According to the relational expression

$$F = \frac{{B}^{2} s}{2 {μ}_{0}}$$

between the required maximum suspension force Fₘₐₓ and the magnetic pole area, where F is an electromagnetic attraction force, B is magnetic induction intensity, s is an area, and μ₀ is vacuum permeability, it is derived that the radial magnetic pole area Sᵣ of the suspension teeth X, Y, Z, U, V, and W is as follows:

$${S}_{r} = \frac{1.822 \times {10}^{- 5} {F}_{max}}{{B}_{s}^{2}} \qquad ( 10 )$$

Taking Fₘₐₓ=100N and radial saturation magnetic induction intensity Bₛ=0.8T as an example, it is calculated that the bias magnetic induction intensity of the radial air gaps under the suspension teeth X, Y, V, and W is Bₚ=0.297T, and the radial magnetic pole area of the suspension teeth X, Y, Z, U, V, and W is Sᵣ2850 mm².

The technical means disclosed in the solution of the present invention are not limited to the technical means disclosed in the foregoing embodiments, but also include technical solutions composed of any combination of the foregoing technical features. It should be noted that a person of ordinary skill in the art may further make several improvements and modifications without departing from the principle of the present invention, and the improvements and modifications fall within the protection scope of the present invention.

1. A design method for a six-pole hybrid magnetic bearing with symmetrical suspension forces, wherein taking particularity that a permanent magnet of the six-pole hybrid magnetic bearing with symmetrical suspension forces forms magnetic polarity on a stator suspension tooth as the starting point, the method specifically comprises the following steps:
step 1: calculating the maximum magnetic suspension force in a +x direction;
S1.1: according to the selected ferromagnetic material, determining the saturation magnetic induction intensity of a radial air gap under a suspension tooth Z in the +x direction as Bₛ, setting the bias magnetic induction intensity of radial air gaps under suspension teeth X, Y, V, and W to Bₚ, and determining the radial control magnetic induction intensity generated by radial control windings on the suspension teeth Z and U as Bₖₐ;
S1.2: according to the relationship of three-phase current when an AC magnetic bearing generates the maximum suspension force in the +x direction, determining the radial control magnetic induction intensities generated by radial control windings on the suspension teeth X and Y and radial control windings on the suspension teeth V and W as B_{kb} and B_{kc};
S1.3: determining the synthetic magnetic induction intensities of the radial air gaps under the six suspension teeth X, Y, Z, U, V, and W as Bₓ₁, B_{y1}, B_{z1}, Bᵤ₁, Bᵥ₁, and B_{w1}; and
S1.4: setting the radial magnetic pole area Sᵣ of the suspension teeth X, Y, Z, U, V, and W, and the angular relationship corresponding to the six suspension teeth X, Y, Z, U, V, and W, and determining the expression of the maximum magnetic suspension force Fₓₘₐₓ in the +x direction;
step 2: calculating the maximum suspension force in a +y direction;
S2.1: according to the relationship of the three-phase current when the AC magnetic bearing generates the maximum suspension force in the +y direction, determining the radial control magnetic induction intensities generated by both the radial control windings on the suspension teeth X and Y and the radial control windings on the suspension teeth V and W as B_{y};
S2.2: according to the bias magnetic induction intensity of the radial air gaps under the suspension teeth X, Y, V, and W being Bₚ and the radial control magnetic induction intensities being both B_{y}, determining the synthetic magnetic induction intensities of the radial air gaps under the suspension teeth X, Y, V, and W as Bₓ₂, B_{y2}, Bᵥ₂, and B_{w2}; and
S2.3: according to the radial magnetic pole area Sᵣ of the suspension teeth X, Y, V, and W, and the angular relationship corresponding to the four suspension teeth X, Y, V, and W, determining the expression of the maximum magnetic suspension force F_{ymax} in the +y direction;
step 3: solving the equation of Fₓₘₐₓ=F_{ymax} to calculate the bias magnetic induction intensity of the radial air gaps under the suspension teeth X, Y, V, and W as Bₚ; and
step 4: calculating the radial magnetic pole area Sᵣ of the suspension teeth X, Y, Z, U, V, and W from the formula
$$F = \frac{{B}^{2} s}{2 {μ}_{0}} ,$$
wherein F is an electromagnetic attraction force, B is magnetic induction intensity, s is an area, and μ₀ is vacuum permeability.

2. The design method for a six-pole hybrid magnetic bearing with symmetrical suspension forces according to claim 1, wherein the relationships of Bₖₐ, B_{kb}, and B_{kc} with Bₛ and Bₚ are:
Bₖₐ=Bₛ−2Bₚ; and
B_{kb}=B_{kc}=Bₚ−½Bₛ.

3. The design method for a six-pole hybrid magnetic bearing with symmetrical suspension forces according to claim 2, wherein the angular relationship corresponding to the suspension teeth X, Y, Z, U, V, and W in S1.4 and S2.3 is that: these suspension teeth are 60 degrees different from each other on the circumference.

4. The design method for a six-pole hybrid magnetic bearing with symmetrical suspension forces according to claim 3, wherein the expression of the maximum magnetic suspension force Fₓₘₐₓ in the +x direction is:
$${F}_{xmax} = \frac{\begin{matrix}[ {B}_{s}^{2} - {( 4 {B}_{p} - {B}_{s} )}^{2} + \frac{1}{2} {( 0.5 {B}_{s} )}^{2} + \frac{1}{2} {( 0.5 {B}_{s} )}^{2} - \\ \frac{1}{2} {( 0.5 {B}_{s} - 2 {B}_{p} )}^{2} - \frac{1}{2} {( 0.5 {B}_{s} - 2 {B}_{p} )}^{2} ] {S}_{r}\end{matrix}}{2 {μ}_{0}}$$
wherein μ₀ is vacuum permeability, and μ₀=4π×10⁻⁷ H/m.

5. The design method for a six-pole hybrid magnetic bearing with symmetrical suspension forces according to claim 3, wherein the expression of the maximum magnetic suspension force F_{ymax} in the +y direction is:
$${F}_{ymax} = \frac{[ \frac{\sqrt{3}}{2} {( 2 {B}_{p} )}^{2} + \frac{\sqrt{3}}{2} {( - 2 {B}_{p} )}^{2} ] {S}_{r}}{2 {μ}_{0}} .$$
